(19) United States
(12) Patent Application Publication
(10) Pub. No.: US 2020/0049404 A1
(43) Pub. Date: Feb. 13, 2020

(54) ELASTOMER DRYING METHOD, ELASTOMER MANUFACTURING METHOD, ELASTOMER DRYING APPARATUS, AND ELASTOMER MANUFACTURING SYSTEM

(71) Applicant: ZEON CORPORATION, Tokyo (JP)

(72) Inventors: Toshihiro INOUE, Tokyo (JP); Hiroshi NAKANO, Tokyo (JP)

(73) Assignee: ZEON CORPORATION, Tokyo (JP)

(21) Appl. No.: 16/496,404

(22) PCT Filed: Mar. 27, 2018
(86) PCT No.: PCT/JP2018/012451

§ 371 Date: Sep. 20, 2019

(30) Foreign Application Priority Data
Mar. 30, 2017 (JP) 2017-068821

(51) Int. Cl. F26B 17/04; B29B 13/06; F26B 25/08

(52) U.S. Cl. CPC F26B 17/04; B29K 2021/003; F26B 25/08; B29B 13/065

(57) ABSTRACT

An elastomer drying method and a drying apparatus capable of preventing elastomer powder from being attached to an inner surface of a wall of a drying chamber. An elastomer drying method dries elastomer while an inner surface of a wall is wet by spraying water from a spray nozzle to the inner surface of the wall facing an orienter in a drying chamber. Further, an elastomer drying apparatus includes a drying chamber into which in-process elastomer is input and which dries the elastomer therein and water spray means for spraying water from a spray nozzle to the wall facing the orienter in the drying chamber so as to wet the wall.

### TECHNICAL FIELD

The present invention relates to an elastomer drying method, an elastomer manufacturing method, an elastomer drying apparatus, and an elastomer manufacturing system.

### BACKGROUND ART

At the time of manufacturing elastomer, slurry containing elastomer solidified after polymerization contains a large amount of water. In order to ship the elastomer as a product, the elastomer needs to be dewatered and dried. As an apparatus for drying in-process elastomer, for example, one shown in Patent Document 1 is known.

However, in an elastomer drying apparatus and an elastomer drying method of the related art, a problem arises in that elastomer powder is attached and deposited on an inner surface of a wall of a drying chamber. When the deposit of the elastomer powder attached to the inner surface of the wall of the drying chamber is just left in that state, the deposit is separated and dropped and is mixed with the elastomer in a drying state to become foreign matter. A method of coating the surface of the wall with fluorine resin is considered in order to prevent the attachment of the elastomer to the wall, but in the elastomer drying apparatus, the deposit is produced by the attachment of the elastomer powder even in the inner surface of the wall coated with fluorine resin.

### CITATION LIST

### Patent Document

Patent Document 1: JP 11-198137 A

### SUMMARY OF THE INVENTION

### Problem to be Solved by the Invention

The invention has been made in view of such circumstances and a first object is to provide an elastomer drying method and an elastomer drying apparatus capable of preventing elastomer powder from being attached to an inner surface of a wall of a drying chamber. Further, a second object of the invention is to provide an elastomer manufacturing method and an elastomer manufacturing system with less mixture of foreign matter in the drying of the elastomer.

### Means for Solving Problem

The present inventor has found that the deposition of elastomer on the inner surface of the drying chamber is prevented when the elastomer is dried while the inner surface of the wall of the drying chamber is wetted with water. In addition to the above-described one, it has found to be effective to wet the inner surface of the wall of the drying chamber with desired water by spraying water thereto as a result of repeatedly examining a number of methods of uniformly wetting the inner surface of the drying chamber by an appropriate amount of water at low cost.

That is, in order to attain the first object, an elastomer drying method of the invention comprising: spraying water to an inner surface of a wall forming a drying chamber for drying in-process elastomer so that the inner surface of the wall is wetted with the water.

Further, in order to attain the first object, the elastomer drying apparatus of the invention includes: a drying chamber into which the in-process elastomer is input and which dries the elastomer therein; and water spray means for spraying water to the inner surface of the wall so as to wet the inner surface of the wall.

According to the elastomer drying method and the elastomer drying apparatus of the invention, since the inner surface of the wall forming the drying chamber is wetted with water, elastomer powder attached to the inner surface of the wall is dropped along with water existing on the inner surface of the wall while the elastomer is being dried. For that reason, since the gradual attachment and deposition of elastomer powder on the inner surface of the wall are prevented, it is possible to reduce the concern that the deposit may be separated and mixed with the elastomer in a drying state.

In the invention, a state in which the inner surface of the wall is wetted with water means a state in which the elastomer is being dried and water always exists in a hydrophilic state on the inner surface of the wall.

Conventionally, water droplets are formed on a hydrophobic surface such as a surface coated with fluorine resin in the early stage of a drying operation, elastomer powder is attached to the water droplets, and the elastomer powder particles are pulled to the inner surface due to the surface tension of the water droplets at the time of drying the water droplets during the drying operation. Then, the elastomer powder particles pulled to the inner surface of the wall are thermally deformed to be attached to the inner surface of the wall and the elastomer powder particles are further deposited thereon. When the deposit of the elastomer degraded by the deposition and thermal deformation is dropped and is mixed with the elastomer in a drying state, the deposit serves as foreign matter in the elastomer product.

In the invention, the elastomer powder attached to the inner surface of the wall is dropped along with water existing on the inner surface of the wall. For that reason, since the gradual attachment and deposition of elastomer powder on the inner surface of the wall are prevented, it is possible to reduce the concern that the deposit may be separated and mixed with the elastomer in a drying state.

Desirably, in the invention, water is sprayed to an upper portion of the inner surface of the wall and is dropped along the inner surface of the wall so as to wet the inner surface of the wall. According to such a method, it is possible to efficiently wet the inner surface of the wall with water.

Further, desirably, in the invention, the water spray means includes a spray nozzle and the spray nozzle is means for spraying water toward at least an upper portion of the inner surface of the wall. According to such an apparatus, it is possible to efficiently wet the inner surface of the wall with water.

As an example of the elastomer drying method, elastomer crumb pushed out of an extruder may be guided onto a conveyor and be dried at a temperature of 100 to 220° C. in the drying chamber.

The elastomer drying apparatus of the invention may further include an extruder which pushes the elastomer into the drying chamber and a conveyor which conveys the elastomer pushed out of the extruder.

In order to attain the second object of the invention, the elastomer manufacturing method of the invention includes drying elastomer by any one of the above-described elastomer drying methods.

In order to attain the second object of the invention, the elastomer manufacturing system of the invention includes any one of the above-described elastomer drying apparatus.

In the elastomer manufacturing method and the elastomer manufacturing system of the invention, since it is possible to prevent the mixture of the deposit from the inner surface of the wall of the drying chamber in the drying of the elastomer, it is possible to manufacture high-quality elastomer with less mixture of foreign matter.

### BRIEF DESCRIPTION OF DRAWINGS

FIG. 1 is a schematic diagram of an elastomer drying apparatus according to an embodiment of the invention; and

FIG. 2 is a diagram for describing a state in which a wall of a drying chamber of a drying apparatus illustrated in FIG. 1 is wetted by a spray nozzle.

### MODE(S) FOR CARRYING OUT THE INVENTION

Hereinafter, the invention will be described with reference to the embodiment illustrated in the drawings.

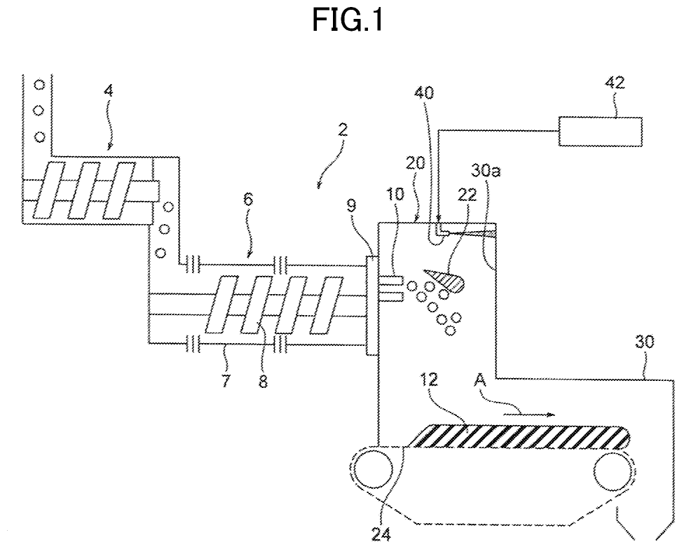

As illustrated in FIG. 1, an elastomer drying apparatus 2 according to the embodiment includes a dehydrator 4, an extruder 6, and a drying chamber 20.

The dehydrator 4 is not particularly limited, but a dehydrator of a type that squeezes water out of a barrel while axially feeding elastomer slurry containing water with a screw is used. The elastomer containing a large amount of water supplied from a polymerization tank is supplied to a dehydrator, for example, after the water is removed by a vibrating screen. The water separated by the screen is returned as hot water.

As a result of the separation of the water by a second vibration screen, the moisture content of the elastomer to be supplied to the dehydrator 4 is about 50% by weight. In the dehydrator 4, the water can be dried to about 8 to 12% by weight. The elastomer dewatered by the dehydrator 4 is supplied to a hopper of the extruder 6 (expansion type extruder drying apparatus).

The hopper of the extruder 6 is provided with a drain hole and a part of water contained in the elastomer is discharged to the outside therefrom. However, the other water is carried along with the elastomer inside a barrel 7 by a screw 8 to an outlet of a die 9 and is not discharged halfway. A set of a dice and an orienter 10 is disposed in the die 9.

The number of the dices and the orienters 10 to be arranged is not particularly limited, but in the embodiment, about five sets are provided. The elastomer which is carried to the die 9 by the screw 8 is discharged from the orienter 10 through a dice hole. Since there is no discharge port except for the dice in the course of the barrel 7 and the die 9, the pressure of the elastomer in the die 9 is about 4 to 9 MPa.

In the extruder 6, the temperature of the elastomer is raised by the warming of the barrel jacket and the shear heating of the elastomer in accordance with the rotation of the screw 8. The temperature of the elastomer is adjusted by controlling the temperature of the heating fluid flowing inside the barrel jacket. The temperature (the outlet temperature) of the die 9 is dependent on the type, molecular weight, Mooney viscosity, and the like of elastomer. However, for example, in the case of butadiene rubber (BR), the temperature is generally controlled in the range of 110 to 150° C. and in the case of styrene-butadiene rubber (SBR), the temperature is generally controlled in the range of 130 to 170° C. That is, the elastomer crumb is pushed out of the orienter 10 in the drying chamber 20 in the temperature range of 100 to 220° C. and desirably 100 to 180° C.

Additionally, these temperature values are determined so that the moisture content of the elastomer discharged from the extruder 6 becomes 4 to 7% by weight and are different in accordance with the type and the like of the elastomer. In this way, since the die 9 is high in temperature and pressure, the pressure of the die 9 is normally higher than the vapor pressure of the water in the elastomer. When the water and the elastomer in the die are discharged from the dice, the water becomes vapor and the elastomer is pushed out of the dice in a porous state. The orienter 10 has a directing passage of a predetermined length and directs the projecting direction of the crumb-like elastomer discharged from the discharge hole of the dice.

The orienter 10 which is attached to the outlet of the extruder 6 extends to the inside of the drying chamber 20 and a formation member 22 corresponding to a dispersion member is disposed in front of a blower of the orienter 10 inside the drying chamber 20. In the embodiment, the formation member 22 has a conical shape. The formation member 22 is disposed to be inclined by a predetermined angle so that its axis becomes a horizontal axis substantially parallel to the axis of the extruder. The angle is adjusted by the adjustment of the attachment position or the length of two or more adjustment bars suspending the formation member 22 from a ceiling.

A distance between the orienter 10 and the formation member 22 (a distance until the elastomer discharged from the orienter 10 collides with the formation member 22) is desirably about 500 to 1500 mm. The crumb-like elastomer (the in-process elastomer) discharged from the orienter 10 is brought into contact with the peripheral surface of the formation member 22 and is directed toward a perforated belt 24 for a conveyor disposed in the drying chamber 20 so as be uniformly dispersed and deposited.

The drying chamber 20 includes the perforated belt 24 which is moved in a conveying direction A by a roller. The perforated belt 24 is formed as, for example, a stainless plate member having an opening ratio of about 30 to 40%. The hole size is set to a degree that crumb-like elastomer 12 deposited on the belt 24 does not fall. A nozzle (not illustrated) is disposed below the belt 24 and drying air discharged from the nozzle is sprayed from the back surface of the belt 24 on which the elastomer 12 is deposited. In the embodiment, the temperature of the drying air is about 50 to 95° C.

In the embodiment, as illustrated in FIG. 1, the orienter 10, the formation member 22, and the belt 24 having the elastomer 12 deposited thereon are covered by a housing wall 30 and the inner temperature of the housing wall 30 is set to be constant in order to improve the drying efficiency in the drying chamber 20.

Additionally, the housing wall 30 of the drying chamber 20 is desirably formed of metal such as stainless steel, iron, nickel, aluminum, chromium, copper, and various metal alloys. By using such metal, the wettability to water is improved. On the other hand, the housing wall 30 may be formed of a material other than metal, for example, a ceramic material such as alumina or zirconia, a glass material such as borosilicate glass or quartz glass, an epoxy resin, and a resin material such as ABS or PET. Further, the inner surface of the housing wall 30 may be subjected to a hydrophilic treatment by a treatment such as a silanol treatment, an alkali treatment, coating of a hydrophilic paint, coating of a hydrophilic film, corona discharge, and the like. Further, the surface roughness of the inner surface of the housing wall 30 may be controlled to improve the wettability to water. Further, the control of the surface roughness may be used in combination with a hydrophilic treatment or the control of the surface roughness alone may improve the wettability to water.

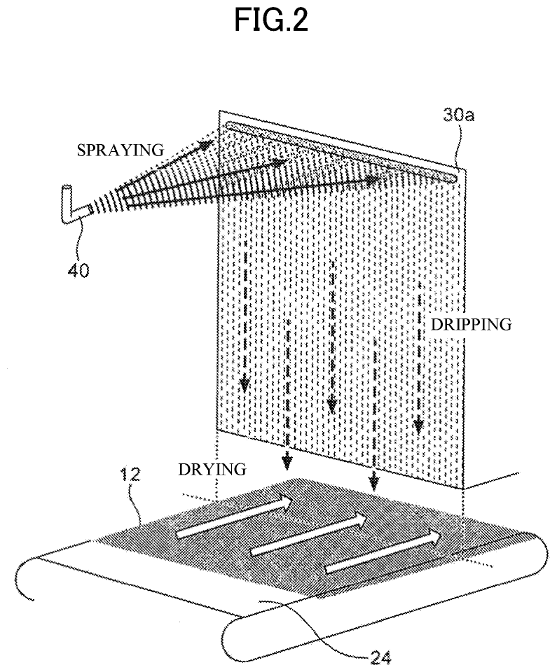

The spray nozzle 40 is provided at a position close to the surface (ceiling surface) of the drying chamber 20. The spray nozzle 40 sprays the water supplied from the water supply apparatus 42 toward a wall 30a facing the orienter 10 in the drying chamber 20. The spray nozzle 40 of the embodiment is a spray nozzle which sprays water in a fan-like shape (fan shape) as illustrated in FIG. 2. Further, the spray nozzle 40 is a nozzle of which a droplet area becomes narrow (nearly straight) and which sprays water so as to have a uniform flow rate distribution in the entire droplet area.

In the elastomer drying apparatus 2 of the embodiment, water is sprayed from the spray nozzle 40 to the wall 30a facing the orienter 10 in the drying chamber 20 as illustrated in FIG. 2. That is, water is uniformly sprayed to the entire area in the width direction in the vicinity of the uppermost portion of the wall 30a facing the orienter 10 in the drying chamber 20. The water sprayed to the vicinity of the uppermost portion of the wall 30a gradually drips down along the wall 30a. As a result, the wall 30a is wet in the entire area as illustrated in the drawings.

The water dripping down along the wall 30a is further dropped onto the perforated belt 24 from the lower edge of the wall 30a. The water dropped onto the perforated belt 24 is exposed to the drying air stream along with the elastomer 12 on the perforated belt 24 in accordance with the movement of the perforated belt 24. As a result, the water dropped onto the elastomer 12 is evaporated along with the water contained in the elastomer 12.

The dried elastomer 12 deposited on the belt 24 is separated from the surface of the belt 24, is crushed, and is discharged to a weighing unit. After the dried elastomer is weighed in the weighing unit, the elastomer is molded, examined, packaged, and shipped. Alternatively, the dried elastomer (for example, rubber) 12 is compressed or formed into, for example, a rubber bale and then is packaged and shipped.

As described above, the moisture content of the elastomer supplied to the dehydrator 4 illustrated in FIG. 1 is about 50% by weight. The elastomer is dewatered by the dehydrator 4 so that the moisture content of the elastomer becomes about 8 to 12% by weight. When the elastomer is supplied into the extruder 6 and is carried by the screw 8, the elastomer containing water is compressed to a water vapor pressure or more. For this reason, when the elastomer containing water is discharged from a dice (not illustrated) to the atmosphere, the elastomer is expanded and cracked. Accordingly, the water becomes vapor and the elastomer becomes porous crumb-like elastomer.

The discharge direction of the crumb-like elastomer discharged from the dice is adjusted by the orienter 10 so that the elastomer collides with the formation member 22. The crumb-like elastomer colliding with the peripheral surface of the formation member 22 is uniformly dispersed on the perforated belt 24 of the drying chamber 20. As the perforated belt 24 moves, the crumb-like elastomer 12 dispersed thereon to have a predetermined thickness moves in the conveying direction A and is halfway exposed to drying air raised upward. The drying air passes through the crumb-like elastomer 12 having a predetermined thickness from many holes of the belt so as to dry the elastomer.

According to the elastomer drying method and the elastomer drying apparatus 2 of the embodiment, since the wall 30a facing the orienter 10 in the housing wall 30 forming the drying chamber 20 is wetted with water sprayed from the spray nozzle 40, the elastomer powder which tries to be attached to the inner surface of the housing wall 30a during the drying of the elastomer 12 is dropped along with water existing on the inner surface of the wall 30a.

For that reason, since the gradual attachment and deposition of the elastomer powder on the inner surface of the wall 30a are prevented, it is possible to reduce the concern that the deposit (containing thermally degraded products of elastomer) is separated and mixed with the elastomer 12 in a drying state. In addition, there is no problem in that the elastomer powder dropped along with water is mixed with the elastomer 12 in a drying state. Even when the elastomer powder to be degraded is mixed with the elastomer 12, the elastomer powder is dried together and is provided as a product. As a result, the elastomer powder does not become foreign matter.

Conventionally, water droplets are formed on a hydrophobic surface such as a surface coated with fluorine resin in the early stage of a drying operation, elastomer powder is attached to the water droplets, and elastomer powder particles are pulled by the inner surface due to the surface tension of the water droplet when the water droplets are dried during the drying operation. Then, the elastomer powder particles pulled to the inner surface of the wall are thermally deformed and are attached to the inner surface of the wall. Subsequently, the elastomer powder particles are deposited thereon. When the deposit of the elastomer degraded by the deposition and thermal deformation is dropped and is mixed with the elastomer in a drying state, the deposit serves as foreign matter in the elastomer product.

In the embodiment, water is sprayed from the spray nozzle 40 to the upper portion of the wall 30a facing the orienter 10 in the drying chamber 20 so that water drips down along the wall 30a to wet the entire surface of the wall 30a by water. Thus, the elastomer powder which tries to be attached to the inner surface of the wall 30a is dropped down along the wall 30a wetted with water. For that reason, since the gradual attachment and deposition of elastomer powder on the inner surface of the wall 30a are prevented, it is possible to reduce the concern that the deposit may be separated and mixed with the elastomer 12 in a drying state. Further, in the embodiment, the inner surface of the wall can be efficiently wetted with water.

The elastomer which is dried by using the drying method of the embodiment is not particularly limited as long as it is a polymer having rubber elasticity. So-called synthetic rubbers and thermoplastic elastomers can be exemplified and can be widely applied to these elastomers. Specifically, synthetic rubbers such as styrene-butadiene rubber (SBR), nitrile-butadiene rubber (NBR), butadiene rubber (BR), isoprene rubber (IR), acrylic rubber, polyether rubber, and hydrin rubber; thermoplastic elastomers such as styrene-isoprene-styrene block polymer (SIS), styrene-butadiene-styrene block polymer (SBS), and hydrogenated block polymers thereof; and the like can be widely applied to general synthetic rubbers or thermoplastic elastomer.

In the elastomer manufacturing method and the elastomer manufacturing system of the embodiment, since the mixture of the deposit from the inner surface of the wall 30a of the drying chamber 20 can be prevented in the drying of elastomer, high-quality elastomer (for example, rubber bale) with less mixture of foreign matter can be manufactured.

Additionally, the invention is not limited to the above-described embodiment and can be modified into various forms within the scope of the invention.

For example, in the above-described embodiment, water was sprayed to the housing wall 30 of the drying chamber 20 by using the spray nozzle 40 corresponding to a uniform fan-like nozzle. However, the spray nozzle used as the spray nozzle 40 is not limited thereto and a nozzle that sprays water in a conical shape may be used. Further, water may be sprayed to the wall 30 by using a rotary nozzle that sprays water while changing the direction of the water linearly advancing in a bar shape.

Further, in the above-described embodiment, water was sprayed to the vicinity of the uppermost portion of the wall 30a and the water dripped along the wall 30a so as to wet the entire surface of the wall 30a with water. However, the entire surface of the wall 30a may be directly sprayed with water by, for example, the nozzle spraying water in a conical shape, the rotary nozzle, or the nozzle of the embodiment spraying water in a fan shape while changing the water spraying angle.

Further, in the above-described embodiment, the wall 30a facing the orienter 10 in the drying chamber 20 is wetted with water by the spray nozzle 40. This is because the elastomer powder is most easily attached to that portion. However, there is a possibility that the elastomer may be deposited on the other walls of the drying chamber 20. Accordingly, these walls may be also wetted with water. As a method of wetting these walls with water, a new spray nozzle may be provided in addition to the above-described nozzle so as to wet these walls with water or the same nozzle may be used to wet these walls with water by widening the water spraying angle of the spray nozzle.

Further, the material sprayed from the spray nozzle 40 to wet the wall 30 of the drying chamber 20 is not limited to water in a pure meaning or strict meaning and may be other liquids. An arbitrary liquid may be used as long as the liquid does not affect the quality of the manufactured elastomer due to the effect of preventing the attachment of the elastomer powder as the liquid drips down along the wall 30.

Further, in the above-described embodiment, water dripping along the wall is dropped onto the perforated belt. However, a configuration such as a “gutter” may be provided under a lower edge of a wall so as to collect water dropped from the wall.

Further, in the above-described embodiment, the elastomer drying apparatus 2 includes the dehydrator 4, the extruder 6, and the drying chamber 20. However, this configuration is only one preferred embodiment and the invention is not limited to this configuration. For example, the dehydrator 4 or the extruder 6 may be configured in a different manner or these components may not be provided. The dehydrator 4 or the extruder 6 is not an essential configuration of the invention. The feature of the invention is that a method and a configuration for inputting elastomer into the drying chamber 20 may be arbitrarily determined in the configuration of the drying chamber 20 or the drying method of the drying chamber 20.

### EXAMPLES

Hereinafter, the invention will be described in more detail with reference to examples, but the invention is not limited to these examples.

### Example 1

As the elastomer of Example 1, SBR manufactured by solution polymerization and having an average molecular weight of 20.0×10⁴ and a Mooney viscosity (a value measured at a temperature of 100° C. according to JIS K6300-1: 50 units of ML₁₊₄, 100° C.) was used. This SBR was dried by using an apparatus illustrated in FIG. 1. The moisture content of the elastomer supplied to the dehydrator 4 was 50% by weight.

The moisture content of the elastomer dewatered by the dehydrator 4 was 10% by weight. The elastomer of the moisture content of 10% by weight was dried by the extruder 6. The outlet temperature of the extruder 6 was set to 130° C.

The moisture content of the elastomer discharged from the dice was 5% by weight as an examination. The elastomer having a moisture content of 5% by weight was brought into contact with the formation member 22 illustrated in FIG. 1 so as to be uniformly dispersed and deposited on the perforated belt 24 of the drying chamber 20. At this time, water was sprayed from the spray nozzle 40 to the wall 30a facing the orienter 10 in the drying chamber 20 at an amount of water of 0.6 L/min/m² (spraying water at 0.6 liters per minute per 1 m² of wall).

The moisture content of the elastomer dried by the drying chamber 20 was 0.8% by weight. Additionally, the moisture content of the elastomer was measured according to JIS-K-6383 after drying the crumb at 105±5° C. for 1 hour, leaving the crumb in a desiccator to be cooled down, and taking the weight difference before and after the drying operation as the moisture content on the basis of (water content)/(water content+polymer before and after drying) as a percentage.

The elastomer dried in this way was visually observed. Here, no thermal degradation was observed and non-powdery porous elastomer was obtained. Further, no foreign matter mixed with the elastomer of 20000 kg was observed. No deposition of the elastomer powder on the inner surface of the wall 30a was observed before and after the running operation for 10 hours.

### Comparative Example 1

The elastomer was manufactured in the same condition as that of Example 1 except that water was not sprayed from the spray nozzle 40 to the housing wall 30 and the same evaluation was performed. The mixture of foreign matter considered as powdery deposit was observed in the elastomer. Further, the deposition of the elastomer powder on the inner surface of the wall 30a facing the orienter 10 in the drying chamber 20 was observed.

### Example 2 and Comparative Example 2

The type of elastomer was replaced by NBR (Nipol DN3350 manufactured by Zeon Corporation through emulsion polymerization, Mooney viscosity 50), the outlet temperature of the dehydrator 4 was set to 120° C., the NBR was input (air-fed) to the drying chamber without passing through the extruder 6, and the same evaluation as those of Example 1 and Comparative Example 1 was performed. Since the elastomer is uniformly dispersed and deposited on the perforated belt 24 in the drying chamber 20, it is similar to Example 1 and Comparative Example 1 in that the air-fed elastomer collides with the formation member 22. As a result, the same result as those of Example 1 and Comparative Example 1 could be obtained even when NBR was input (air-fed) to the drying chamber without passing through the extruder 6.

### Example 3 and Comparative Example 3

The type of elastomer was replaced by BR (Nipol BR 1220 manufactured by Zeon Corporation through solution polymerization, Mooney viscosity 44), the outlet temperature of the extruder 6 was set to 110° C., and the same evaluation as those of Example 1 and Comparative Example 1 was performed. Here, the same result could be obtained.

### Example 4 and Comparative Example 4

The type of elastomer was replaced by IR (Nipol IR2200 manufactured by Zeon Corporation through solution polymerization, Mooney viscosity 82), the outlet temperature of the extruder 6 was set to 210° C., and the same evaluation as those of Example 1 and Comparative Example 1 was performed. Here, the same result could be obtained.

### EXPLANATIONS OF LETTERS OR NUMERALS

2 DRYING APPARATUS
4 DEHYDRATOR
6 EXTRUDER
10 ORIENTER
12 ELASTOMER
20 DRYING CHAMBER
22 FORMATION MEMBER
24 PERFORATED BELT
30, 30a WALL
40 SPRAY NOZZLE
42 WATER SUPPLY APPARATUS

1. An elastomer drying method of drying elastomer comprising:
spraying water to an inner surface of a wall forming a drying chamber for drying in-process elastomer so that the inner surface of the wall is wetted with the water.

2. The elastomer drying method according to claim 1,
wherein water is sprayed to an upper portion of the inner surface of the wall and is dropped along the inner surface of the wall so as to wet the inner surface of the wall.

3. The elastomer drying method according to claim 1,
wherein elastomer crumb pushed out of an extruder is guided onto a conveyor and is dried at a temperature of 100 to 220° C. in the drying chamber.

4. An elastomer manufacturing method comprising:
drying elastomer by the elastomer drying method according to claim 1.

5. An elastomer drying apparatus comprising:
a drying chamber into which an in-process elastomer is input for drying the elastomer therein; and
water spray means for spraying water to an inner surface of a wall of the drying chamber so as to wet the inner surface of the wall.

6. The elastomer drying apparatus according to claim 5,
wherein the water spray means includes a spray nozzle and the spray nozzle is means for spraying water toward at least an upper portion of the inner surface of the wall.

7. The elastomer drying apparatus according to claim 5, further comprising:
an extruder for pushing out the elastomer into the drying chamber; and
a conveyor which conveys the elastomer pushed out of the extruder.

8. An elastomer manufacturing system comprising:
the elastomer drying apparatus according to claim 5.

9. The elastomer drying method according to claim 2,
wherein elastomer crumb pushed out of an extruder is guided onto a conveyor and is dried at a temperature of 100 to 220° C. in the drying chamber.

10. An elastomer manufacturing method comprising:
drying elastomer by the elastomer drying method according to claim 2.

11. An elastomer manufacturing method comprising:
drying elastomer by the elastomer drying method according to claim 3.

12. An elastomer manufacturing method comprising:
drying elastomer by the elastomer drying method according to claim 9.

13. The elastomer drying apparatus according to claim 6, further comprising:
an extruder for pushing out the elastomer into the drying chamber; and
a conveyor which conveys the elastomer pushed out of the extruder.

14. An elastomer manufacturing system comprising:
the elastomer drying appartatus according to claim 6.

15. An elastomer manufacturing system comprising:
the elastomer drying appartatus according to claim 7.

16. An elastomer manufacturing system comprising:
the elastomer drying appartatus according to claim 13.
